(19) United States
(12) Patent Application Publication
(10) Pub. No.: US 2020/0273465 A1
(43) Pub. Date: Aug. 27, 2020

(54) SPEECH DEVICE, METHOD FOR CONTROLLING SPEECH DEVICE, AND RECORDING MEDIUM

(71) Applicant: SHARP KABUSHIKI KAISHA, Sakai City, Osaka (JP)

(72) Inventor: HIROYASU HAMAMURA, Sakai City, Osaka (JP)

(21) Appl. No.: 16/495,027

(22) PCT Filed: Dec. 21, 2017
(86) PCT No.: PCT/JP2017/045988

§ 371 Date: Sep. 17, 2019

(30) Foreign Application Priority Data
Mar. 23, 2017 (JP) 2017-057540

(51) Int. Cl. G10L 17/00; G10L 13/02; G10L 17/06; G06K 9/00

(52) U.S. Cl. CPC G10L 17/005; G06K 9/00288; G10L 17/06; G10L 13/02

(57) ABSTRACT

It is an object of the present invention to prevent leakage of personal information or the like to a third party. A smartphone (1) includes: a person state identifying section (13) configured to analyze a captured image of the vicinity of the smartphone (1) so as to carry out identification of a person(s) in the vicinity of the smartphone (1) and the number of the person(s); and a speech permission determining section (14) configured to determine, on the basis of a result of the identification, whether or not speech is to be outputted.

### TECHNICAL FIELD

The present invention relates to a speech device having a function of outputting speech with use of audio, and the like.

### BACKGROUND ART

In order to cause a device to converse with a human, it is necessary to have a technology for detecting a conversation partner from an environment surrounding the device and a technology for recognizing audio. Examples of a method for detecting a conversation partner from a surrounding environment encompass (i) a method in which a plurality of microphones are arranged and a direction of a sound source is presumed with use of a phase difference between the plurality of microphones and (ii) a method in which a position of a speaker who speaks is detected by detecting a human face with use of a camera.

Patent Literature 1 discloses a robot which detects a conversation partner with use of audio information and image information and converses with the conversation partner. The robot is configured to (i) recognize specific audio that has been emanated from a speaker and represents a start of a conversation, (ii) detect a direction of the speaker by presuming a direction from which the audio has been emanated, (iii) moves toward the direction of the speaker thus detected, (iv) detects, after having moved, a face of a person from an image inputted from a camera, and (v) in a case where the face has been detected, carry out a conversation process.

### CITATION LIST

### Patent Literature

[Patent Literature 1]
Japanese Patent Application Publication Tokukai No. 2006-251266 (Publication date: Sep. 21, 2006)

### SUMMARY OF INVENTION

### Technical Problem

The above-described conventional technology, however, has the following problem. That is, in a case where a third party is in the vicinity of a user when the robot outputs, as speech, information related to privacy such as personal information of the user, the user may feel annoyed by the speech of the robot because the speech reveals the personal information or the like of the user to the third party.

The present invention is accomplished in view of the problem. An object of the present invention is to provide a speech device and the like each of which allows preventing leakage of personal information or the like to a third party.

### Solution to Problem

In order to attain the object, a speech device in accordance with an aspect of the present invention is a speech device which has a function of outputting speech with use of audio, including: a person state identifying section configured to analyze a captured image of the vicinity of the speech device so as to carry out at least one of (i) a process of making an identification of a person in the vicinity of the speech device and (ii) a process of making an identification of the number of the person in the vicinity of the speech device; and a speech permission determining section configured to determine, on the basis of a result of the identification, whether or not speech is to be outputted.

In order to attain the object, a method for controlling a speech device in accordance with an aspect of the present invention is a method for controlling a speech device which has a function of outputting speech with use of audio, the method including the steps of: (a) a person state identifying step of analyzing a captured image of the vicinity of the speech device so as to carry out at least one of (i) a process of making an identification of a person(s) in the vicinity of the speech device and (ii) a process of making an identification of the number of the person(s) in the vicinity of the speech device; and (b) a speech permission determining step of determining, on the basis of a result of the identification, whether or not speech is to be outputted.

### Advantageous Effects of Invention

A speech device in accordance with an aspect of the present invention or a method for controlling the speech device allows preventing leakage of personal information or the like to a third party.

### BRIEF DESCRIPTION OF DRAWINGS

FIG. 1 is a block diagram illustrating a configuration of a communication system in accordance with an embodiment of the present invention.

FIG. 2 is a diagram illustrating an external appearance of a smartphone and a charging station which are included in the communication system.

FIG. 3 is a diagram illustrating a method in accordance with which an image of a person is captured by the communication system.

FIG. 4 is a flowchart of an operation carried out by the communication system.

(a) and (b) of FIG. 5 are views each illustrating a relationship between (i) the presence or absence of private information and (ii) speech content. (c) of FIG. 5 is a diagram illustrating a relationship between a type of information and a confidentiality level of the information.

### DESCRIPTION OF EMBODIMENTS

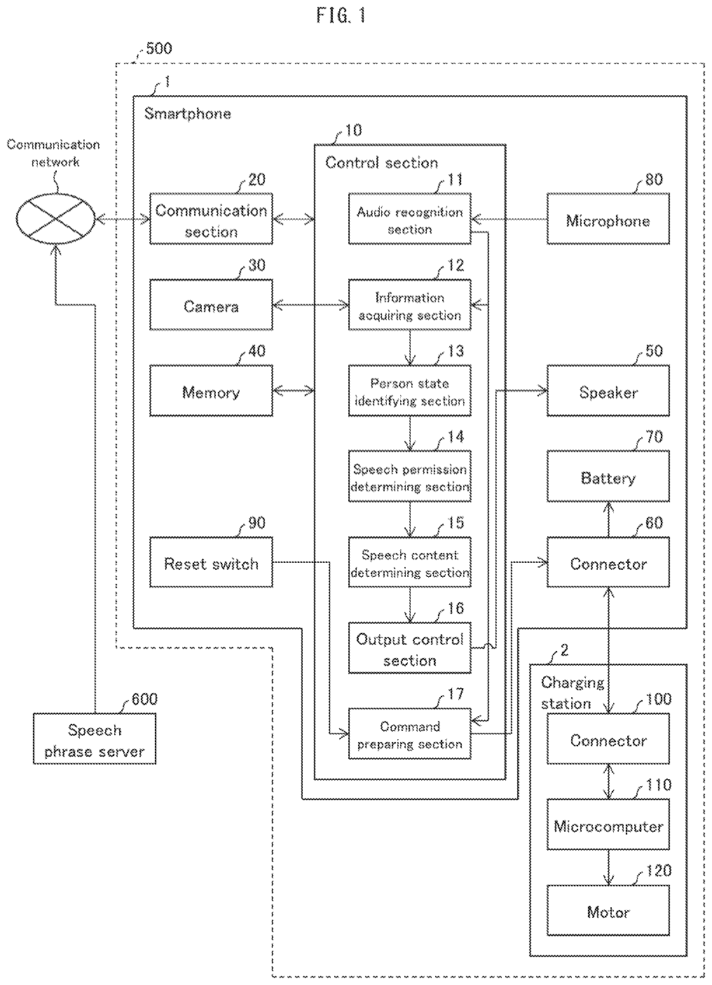

The following description will discuss, with reference to FIGS. 1 through 5, an embodiment of the present invention. For convenience, in each item of the description below, configurations similar in function to those described in other items will be given the same reference signs, and their description may be omitted.

Overview of Communication System

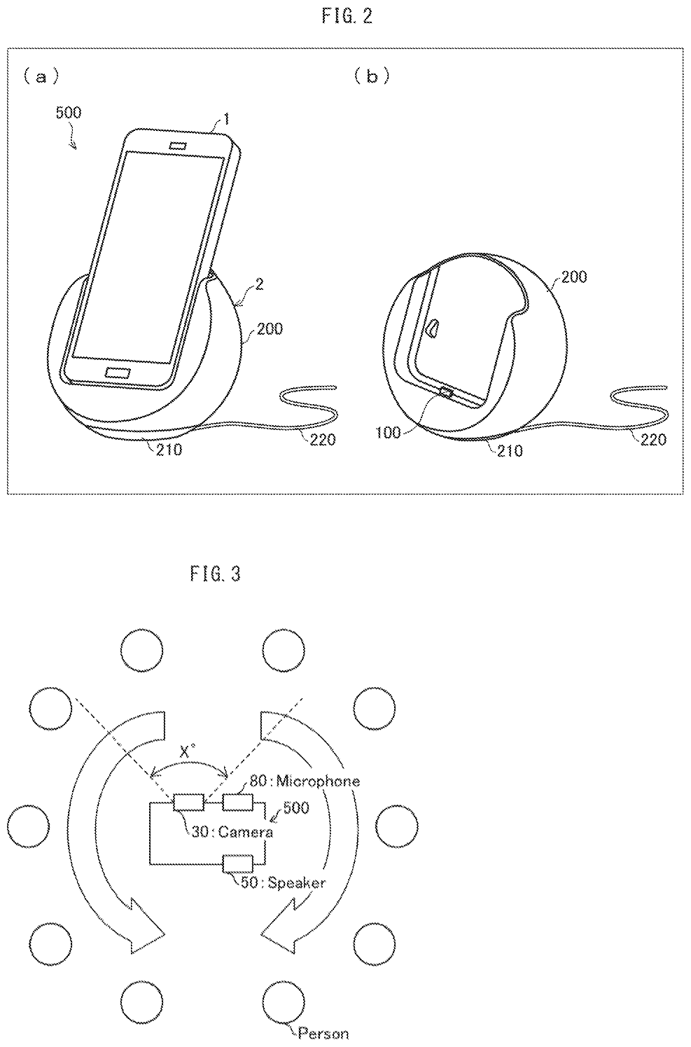

A communication system 500 in accordance with the present embodiment of the present invention includes a smartphone (speech device) 1 and a charging station 2 to which the smartphone 1 can be mounted. With reference to FIG. 2, the following description will discuss example external appearances of the smartphone 1 and the charging station 2.

FIG. 2 is a diagram illustrating an external appearance of the smartphone 1 and the charging station 2 which are included in the communication system 500 in accordance with the present embodiment. (a) of FIG. 2 illustrates the smartphone 1 and the charging station 2 in a state where the smartphone 1 has been mounted to the charging station 2.

The smartphone 1 is an example of a speech device having a function of outputting speech with use of audio. The smartphone 1 includes a control device (control section 10; described later) which controls various functions of the smartphone 1. A speech device in accordance with the present invention is not limited to a smartphone, provided that the speech device has a function of outputting speech. For example, the speech device may be a terminal device such as a mobile phone or a tablet PC, or may be a home appliance, a robot, or the like which has a function of outputting speech.

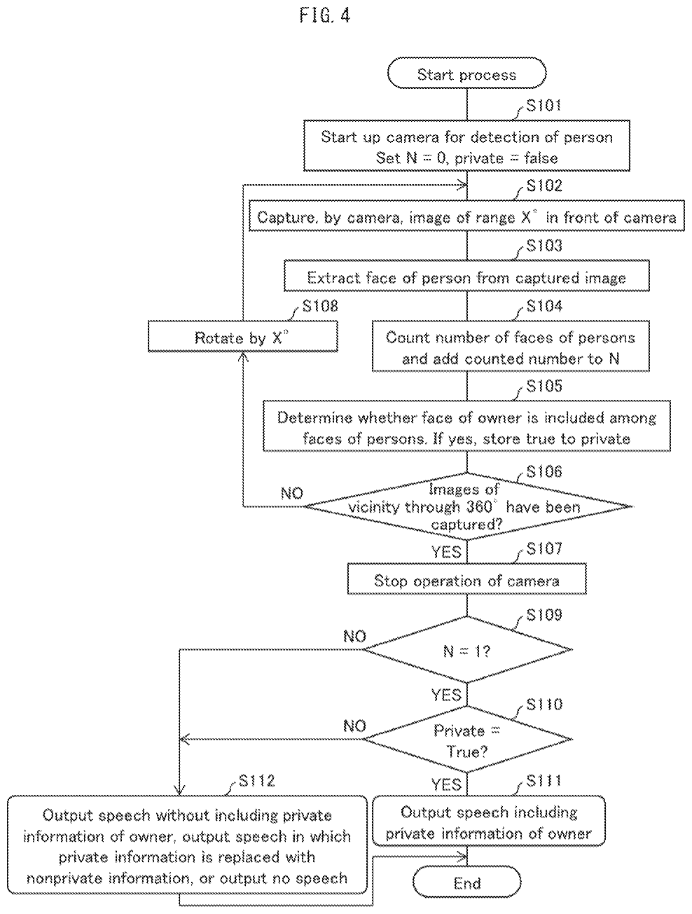

The charging station 2 is a cradle to which the smartphone 1 can be mounted. The charging station 2 is capable of rotating while the smartphone 1 is mounted to the charging station 2. Rotation of the charging section 2 will be described later with reference to FIG. 3. The charging station 2 includes a steadying section 210 and a housing 200. The charging station 2 may include a cable 220 for connection to a power source.

The steadying section 210 is a base portion of the charging station 2 which steadies the charging station 2 when the charging station 2 is placed on, for example, a floor or a desk. The housing 200 is a portion in which the smartphone 1 is to be seated. The shape of the housing 200 is not particularly limited, but is preferably a shape which can reliably hold the smartphone 1 during rotation. In a state where the housing 200 holds the smartphone 1, the housing 200 can be rotated by motive force from a motor (motor 120; described later) which is provided inside the housing 200. A direction in which the housing 200 rotates is not particularly limited. The following descriptions assume an example in which the housing 200 rotates left and right around an axis which is substantially perpendicular to a surface on which the steadying section 210 is placed. As such, the smartphone 1 can be caused to rotate so as to capture images of the vicinity of the smartphone 1.

(b) of FIG. 2 is a diagram illustrating an external appearance of the charging station 2 in a state where the smartphone 1 is not mounted to the charging station 2. The housing 200 includes a connector 100 for connection with the smartphone 1. The charging station 2 receives various instructions (commands) from the smartphone 1 via the connector 100 and operates in accordance with the commands. Note that it is possible to use, in place of the charging station 2, a cradle which does not have a charging function and, as with the charging station 2, is capable of holding the smartphone 1 and causing the smartphone 1 to rotate.

Configuration of Main Parts

FIG. 1 is a block diagram illustrating an example configuration of main parts of the communication system 500 (the smartphone 1 and the charging station 2). As illustrated in FIG. 1, the smartphone 1 includes the control section 10, a communication section 20, a camera 30, a memory 40, a speaker 50, a connector 60, a battery 70, a microphone 80, and a reset switch 90.

The communication section 20 carries out communication between the smartphone 1 and other devices by sending and receiving information. The smartphone 1 is capable of, for example, carrying out communication between a speech phrase server 600 via a communication network.

The communication section 20 transmits to the control section 10 information received from other devices. For example, the smartphone 1 (i) receives, from the speech phrase server 600 via the communication section 20, a speech phrase, which is a template sentence, and a speech template, which is used for generating the speech phrase and (ii) transmits the speech phrase and the speech template to the control section 10. The camera 30 is an input device for obtaining information indicating a state of the vicinity of the smartphone 1.

The camera 30 captures still images or moving images of an area surrounding the smartphone 1. The camera 30 carries out image capture in accordance with control from the control section 10 and transmits image capture data to an information acquiring section 12 of the control section 10.

The control section 10 carries out overall control of the smartphone 1. The control section 10 includes an audio recognition section 11, the information acquiring section 12, a person state identifying section 13, a speech permission determining section 14, a speech content determining section 15, an output control section 16, and a command preparing section 17.

The audio recognition section 11 carries out audio recognition of audio collected via the microphone 80. The audio recognition section 11 notifies the information acquiring section 12 that the audio has been recognized. The audio recognition section 11 also notifies the command preparing section 17 that the audio has been recognized, and transmits a result of the audio recognition to the command preparing section 17.

The information acquiring section 12 acquires the image capture data. Once the audio recognition section 11 notifies the information acquiring section 12 that the audio has been recognized, the information acquiring section 12 acquires the image capture data obtained by image capture of the vicinity the smartphone 1 carried out by the camera 30. Whenever the information acquiring section 12 acquires the image capture data, the information acquiring section 12 transmits the image capture data to the person state identifying section 13. This enables the person state identifying section 13 (described later) to carry out, at substantially the same time as image capture by the camera 30 and image capture data acquisition by the information acquiring section 12, (i) detection of a facial image of a person and (ii) comparison of the facial image detected and a registered facial image, which has been stored in advance in the memory 40.

The information acquiring section 12 may control turning on and off the camera 30. For example, the information acquiring section 12 may turn on the camera 30 in a case where the audio recognition section 11 notifies the information acquiring section 12 that audio has been recognized. The information acquiring section 12 may also turn off the camera 30 in a case where capture of images of the vicinity of the smartphone 1 through 360° is completed by rotation of the charging station 2 and the smartphone 1 mounted to the charging station 2.

The person state identifying section 13 carries out analysis of the image capture data acquired from the information acquiring section 12. Through the analysis, the person state identifying section 13 (i) extracts a facial image(s) from the image capture data and (ii) identifies, on the basis of the number of the facial image(s) extracted, the number of person(s) in the vicinity of the communication system 500. The person state identifying section 13 also carries out person recognition (a process of identifying the person(s) in the vicinity of the communication system 500) by comparing the facial image(s) extracted from the image capture data with the registered facial image stored in advance in the memory 40. Specifically, the person state identifying section 13 identifies whether or not a person of each of the facial image(s) extracted from the image capture data is a predetermined person (for example, an owner of the smartphone 1). A method for analysis of the image capture data is not particularly limited. As one example, performing pattern matching between each of the facial image(s) extracted from the image capture data and the registered facial image stored in the memory 40 enables determining, and thus identifying, whether or not a person is included in the image capture data.

The speech permission determining section 14 determines, in accordance with the number of the person(s) in the vicinity of the smartphone 1 identified by the person state identifying section 13 and a result of identification of each of the person(s), whether or not speech is to be outputted. For example, the speech permission determining section 14 may determine, in a case where only one (1) predetermined person has been identified, that speech is to be outputted. In a case where the number of the person(s) in the vicinity of the smartphone 1 is only one (1), that person is highly likely to be the owner of the smartphone 1. It is therefore possible to cause the smartphone 1 to output speech in a case where (i) content of the speech includes personal information or the like of the owner but (ii) there is little likelihood of leaking the personal information or the like to a third party.

Further, the speech permission determining section 14 may determine, in a case where two or more persons have been identified, that speech is not to be outputted. In a case where the number of the person(s) in the vicinity of the smartphone 1 is two or more, it is highly likely that a third party who is not the owner of the smartphone 1 is included among the persons. As such, by determining that speech is not to be outputted in a case where two or more persons have been identified, it is possible to prevent leakage of personal information or the like of the owner of the smartphone 1 to a third party.

Further, the speech permission determining section 14 may determine, in a case where a predetermined number (e.g., one (1)) of predetermined person(s) has/have been identified, that speech is to be outputted. With this configuration, the smartphone 1 is caused to output speech only in a case where the number of the person(s) in the vicinity of the smartphone 1 is limited to the predetermined number (e.g., one (1)). This allows preventing speech outputted by the smartphone 1 from causing leakage of personal information or the like to a third party.

Further, the speech permission determining section 14 may determine, in a case where not less than a predetermined number (e.g., two) of person(s) has/have been identified, that speech is not to be outputted. In a case where the number of the person(s) in the vicinity of the smartphone 1 is not less than the predetermined number, it is highly likely that a third party who is not the owner of the smartphone 1 is included among the person(s). As such, by determining that speech is not to be outputted in a case where the number of the person(s) identified is not less than the predetermined number, it is possible to prevent leakage of personal information or the like of the owner of the smartphone 1 to a third party.

As described above, whether or not speech is to be outputted is determined in accordance with a result of identification of a person(s) in the vicinity of the smartphone 1 or a result of identification of the number of the person(s) in the vicinity of the smartphone 1, it becomes possible to prevent speech outputted by the smartphone 1 from causing leakage of personal information or the like to a third party.

Further, the speech permission determining section 14 notifies the speech content determining section 15 of a result of determination of whether or not output of speech is permitted (notifies the speech content determining section 15 that speech is to be outputted or that speech is not to be outputted). In a case where the speech permission determining section 14 notifies the speech content determining section 15 that speech is to be outputted, the speech content determining section 15 (i) receives, from the speech phrase server 600 via the communication section 20, data (the speech phrase, the speech template, and the like) necessary for preparing speech content and (ii) determines speech content.

In a case where (i) only one (1) predetermined person has been identified, (ii) the predetermined person is the owner of the smartphone 1, and (iii) the speech permission determining section 14 has determined that speech is to be outputted, the speech content determining section 15 includes, in the speech content, personal information of the owner. In a case where (i) only one (1) predetermined person has been identified and (ii) the predetermined person is the owner of the smartphone 1, no problem arises from including personal information or the like of the owner of the smartphone 1 in content of the speech, since there is no risk of leaking the personal information or the like of the owner to a third party. Accordingly, in a situation in which nobody is present except for the owner, a conversation can be held on a wide range of topics including a private topic involving the personal information or the like.

Further, in a case where (i) a predetermined number of predetermined person(s) has/have been identified, (ii) each of the predetermined person(s) is a person in the presence of whom the smartphone 1 is permitted to output speech including personal information, and (iii) the speech permission determining section 14 has determined that speech is to be outputted, the speech content determining section 15 may include, in content of the speech, personal information of the person in the presence of whom the smartphone 1 is permitted to output speech including personal information. In a case where (i) a predetermined number of predetermined person(s) has/have been identified and (ii) each of the predetermined person(s) is a person in the presence of whom the smartphone 1 is permitted to output speech including personal information, no problem arises from including personal information in content of the speech, since there is no risk of leaking, to a third party, personal information of the person in the presence of whom the smartphone 1 is permitted to output speech including personal information. Accordingly, in a situation in which nobody is present except for the person in the presence of whom the smartphone 1 is permitted to output speech including personal information, a conversation can be held on a wide range of topics including a private topic involving the personal information or the like.

In a case where (i) the person state identifying section 13 has identified a predetermined person and another person and (ii) the speech permission determining section 14 has determined that speech is to be outputted, the speech content determining section 15 may exclude personal information of the predetermined person from speech content or may replace the personal information with nonpersonal information. This enables a conversation between the smartphone 1 and a user while preventing leakage of personal information or the like of a predetermined person to a third party. Further, the speech permission determining section 14 may determine, only on the basis of the number of person(s) and without carrying out identification of the person(s), whether or not output of speech is to be permitted.

In a case where (i) a confidentiality level has been set in advance to a message to be outputted by the smartphone 1 as speech, (ii) the person state identifying section 13 has identified a plurality of persons, and (iii) the speech permission determining section 14 has determined that speech is to be outputted, the speech content determining section 15 may cause a message of a lower confidentiality level to be outputted, as speech, in accordance with an increase in the number of the persons who have been identified. With this configuration, a confidentiality level for a message that can be outputted as speech is lowered in accordance with an increase in the number of the persons identified. This makes it possible, even in a situation in which a large number of people are in the vicinity of the smartphone 1, to cause the smartphone 1 to output speech while preventing a message of a high confidentiality level from being conveyed to the large number of people.

Further, in a case where (i) a confidentiality level has been set in advance to a message to be outputted by the smartphone 1 as speech, (ii) the person state identifying section 13 has identified a predetermined person and another person, and (iii) the speech permission determining section 14 has determined that speech is to be outputted, the speech content determining section 15 may cause a message of a confidentiality level corresponding to who the another person is to be outputted as speech. This allows adjusting, in accordance with who the another person is, a confidentiality level for a message that can be outputted as speech.

Upon determining speech content, the speech content determining section 15 transmits a result of determination of the speech content to the output control section 16. The output control section 16 causes the speaker 50 to output audio of the speech content determined by the speech content determining section 15.

The command preparing section 17 creates an instruction (command) for the charging station 2 and transmits the instruction to the charging station 2. In a case where the audio recognition section 11 has notified the command preparing section 17 that audio has been recognized, the command preparing section 17 creates a rotation instruction, which is an instruction for causing the housing 200 of the charging station 2 to rotate. The command preparing section 17 then transmits the rotation instruction to the charging station 2 via the connector 60.

Details of the term “rotation” are as follows. In the present embodiment, “rotation” refers to causing the smartphone 1 (the above-described housing 200 of the charging station 2) to rotate clockwise or counterclockwise within the range of 360° in a horizontal plane, as illustrated in FIG. 3. Note that as illustrated in FIG. 3, a range for which the camera 30 of the communication system 500 is capable of image capture is X°. As such, by shifting the range of X° from one position to another without an overlap between the range of X° at the one position and the range of X° at the another position, it is possible to efficiently capture images of people in the vicinity of the smartphone 1. Note that the range of rotation of the housing 200 may be less than 360°.

Furthermore, when the person state identifying section 13 has detected all of the people in the vicinity of the smartphone 1 through 360°, the command preparing section 17 may transmit a stop instruction that instructs the charging station 2 to stop the rotation which is being carried out in accordance with the rotation instruction. Because it is not essential for the charging station 2 to rotate after the people have been detected, transmitting the stop instruction makes it possible to prevent the charging station 2 from rotating unnecessarily.

The memory 40 stores various types of data used in the smartphone 1. The memory 40 may store, for example, a pattern image of a face of a person which the person state identifying section 13 uses for pattern matching, audio data for output controlled by the output control section 16, and templates for commands to be prepared by the command preparing section 17. The speaker 50 is an output device which outputs audio in response to control by the output control section 16.

The connector 60 is an interface for an electrical connection between the smartphone 1 and the charging station 2. The battery 70 is a power source of the smartphone 1. The connector 60 sends to the battery 70 power obtained from the charging station 2, so that the battery 70 is charged. Note that a method of connecting the connector 60 and the connector 100 of the charging station 2 (described later) is not particularly limited. The respective physical shapes of the connector 60 and the connector 100 are not particularly limited. The connector 60 and the connector 100 may be each realized by, for example, a universal serial bus (USB).

The reset switch 90 is a switch for causing the smartphone 1 to stop operating and to resume operating. Note that in the above-described embodiment, trigger for the housing 200 to commence a rotation operation is audio recognition by the audio recognition section 11, but the trigger for the housing 200 to commence a rotation operation is not limited to this. For example, commencement of a rotation operation of the housing 200 may be triggered when the reset switch 90 has been pressed, or when an elapse of a predetermined length of time has been measured by a timer which may be included in the smartphone 1.

Configuration of Main Parts of the Charging Station

As illustrated in FIG. 1, the charging station 2 includes the connector 100, a microcomputer 110, and the motor 120. The charging station 2 can be connected to, for example, a home electrical outlet or a power source (not illustrated) such as a battery via the cable 220.

The connector 100 is an interface for an electrical connection between the charging station 2 and the smartphone 1. In a case where the charging station 2 is connected to a power source, the connector 100 sends, via the connector 60 of the smartphone 1 to the battery 70, power obtained from the power source by the charging station 2, so that the battery 70 is charged.

The microcomputer 110 carries out overall control of the charging station 2. The microcomputer 110 receives commands from the smartphone 1 via the connector 100. The microcomputer 110 controls operations of the motor 120 in accordance with received commands. Specifically, in a case where the microcomputer 110 has received the rotation instruction from the smartphone 1, the microcomputer 110 controls the motor 120 in a manner so as to rotate the housing 200.

The motor 120 is a motor for rotating the housing 200. The motor 120 operates or stops in accordance with control from the microcomputer 110 so as to rotate or stop the steadying section 210.

Operation of Communication System

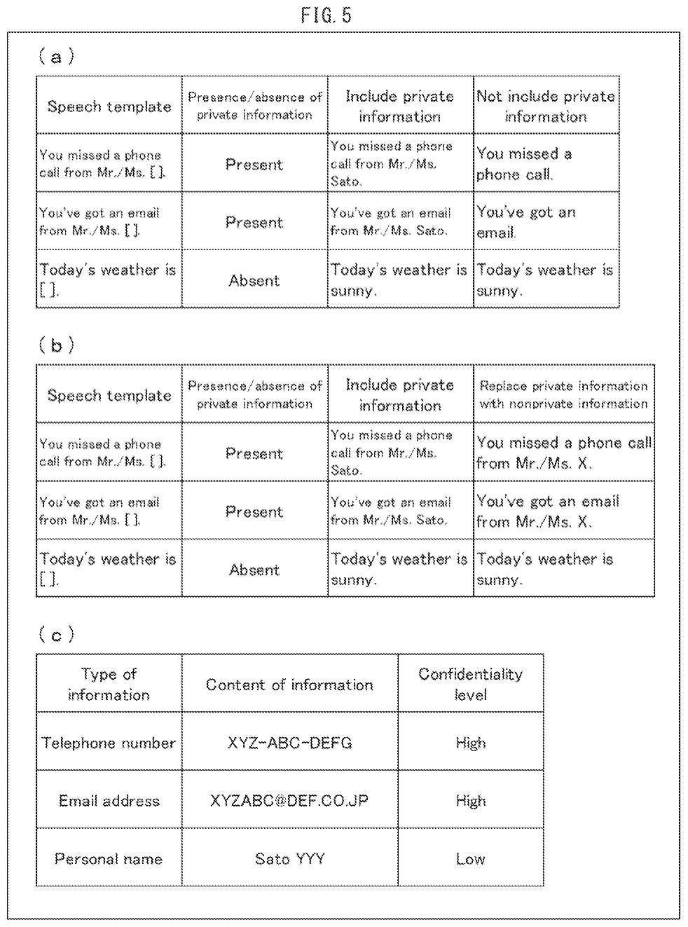

The following description will discuss, with reference to FIG. 4, an operation of the communication system 500 described above. FIG. 4 is a flowchart of an operation carried out by the communication system. Firstly, in a case where the audio recognition section 11 has recognized audio, a process is started.

At S101, the information acquiring section 12 starts up the camera 30 for detection of a person. At this point in time, the person state identifying section 13 sets N=0 and Private=false where N is the number of persons, and the process proceeds to S102. At S102, the camera 30 captures an image of a range of X° in front of the camera 30 (see FIG. 3), and the process proceeds to S103. At S103, the person state identifying section 13 extracts a face(s) of a person(s) from the image captured, and the process proceeds to S104.

At S104, the person state identifying section 13 counts the number of the person(s) extracted and adds the number thus counted to the number N, and the process proceeds to S105. At S105, the person state identifying section 13 determines whether or not a face of the owner is included among the face(s) of the person(s). In a case where a result of determination is “true”, the person state identifying section 13 sets Private=true, and the process proceeds to S106.

At S106, the information acquiring section 12 checks whether or not images of the vicinity of the smartphone 1 through 360° have been captured. In a case where images of the vicinity of the smartphone 1 through 360° have been captured, the process proceeds to S107. For example, assuming that a rotation angle X is 60°, in a case where five rotation operations and image capture with respect to 6 directions have been finished, the information acquiring section 12 determines that images of the vicinity of the smartphone 1 through 360° have been captured. However, in a case where images of the vicinity of the smartphone 1 through 360° have not been captured, the process proceeds to S108. At S108, the housing 200 is caused to rotate clockwise or counterclockwise by X°, and the process proceeds to S102. At S107, the information acquiring section 12 causes the camera 30 to stop operating, and the process proceeds to S109.

At S109, the speech permission determining section 14 checks whether or not the number N of the person(s) identified by the person state identifying section 13 equals one (1). In a case where the number N=1, the process proceeds to S110. However, in a case where the number N*1, the process proceeds to S112. At S110, the speech permission determining section 14 checks whether the person state identifying section 13 has determined that Private=true or that Private=false. In a case of Private=true, the process proceeds to S111. However, in a case of Private=false, the process proceeds to S112. As detailed later, speech output is carried out at S111 but may not necessarily be carried out at S112. It is thus understood that at S109 and S110, the speech permission determining section 14 determines whether or not speech is to be outputted.

At S111, the speech content determining section 15 (i) determines that personal information or the like (private information) of the owner is to be included in speech content and (ii) determines speech content (what kind of a message is to be outputted) in accordance with a result of determination. Then, the output control section 16 causes the speaker 50 to output audio of the speech content determined, and the process is “ended”.

At S112, a process for preventing speech outputted by the smartphone 1 from causing leakage of personal information or the like. Specifically, at S112, any one of processes (1) through (3) is carried out: (1) a process of outputting speech content including no private information of the owner, (2) a process of outputting speech content in which private information is replaced with nonprivate information, and (3) a process of outputting no speech.

In a case of carrying out the process (1) or (2), the speech content determining section 15 determines speech content (what kind of a message is to be outputted). Then, the output control section 16 causes the speaker 50 to output audio of the speech content determined, and the process is “ended”. In a case of carrying out the process (3), the speech permission determining section 14 determines that speech is not to be outputted, and the process is ended without output of speech.

Specific Example of Method of Determining Speech Content

The following description will discuss, with reference to FIG. 5, a specific example of a method of determining speech content. (a) and (b) of FIG. 5 are diagrams each illustrating a relationship between (i) the presence or absence of private information (personal information or the like) and (ii) speech content.

The following discusses a case in which speech content is determined with use of a speech template “You missed a phone call from Mr./Ms. [ ].” illustrated in (a) of FIG. 5. Information that can be inserted inside “[ ]” is private information. For example, in a case where private information is to be included in the speech content (S111 in FIG. 4), a personal name “Sato” is inserted inside “[ ]”. In a case where private information is not to be included in the speech content (S112 in FIG. 4), the portion “from Mr./Ms. [ ]” is deleted so that the speech content is simply “You missed a phone call.”

The following discusses a case in which speech content is determined with use of a speech template “You've got an email from Mr./Ms. [ ].” Information that can be inserted inside “[ ]” is private information. For example, in a case where private information is to be included in the speech content (S111 in FIG. 4), a personal name “Sato” is inserted inside “[ ]”. In a case where private information is not to be included in the speech content (S112 in FIG. 4), the portion “from Mr./Ms. [ ]” is deleted so that the speech content is simply “You've got an email.”

The following discusses a case in which speech content is determined with use of a speech template “Today's weather is [ ].” Information that can be inserted inside “[ ]” is nonprivate information. Both in a case where private information is to be included in the speech content and a case where private information is not to be included in the speech content, the speech content determined is commonly, for example, “Today's weather is sunny.” Thus, in a case of outputting speech including no private information, the process illustrated in FIG. 4 is not essential.

The following discusses a case in which speech content is determined with use of a speech template “You missed a phone call from Mr./Ms. [ ].” illustrated in (b) of FIG. 5. Information that can be inserted inside “[ ]” is private information. For example, in a case where private information is to be included in the speech content (S111 in FIG. 4), a personal name “Sato” is inserted inside “[ ]”. In a case where private information is to be replaced with nonprivate information (S112 in FIG. 4), an alphabet letter “X” is inserted inside “[ ]”.

The following discusses a case in which speech content is determined with use of a speech template “You've got an email from Mr./Ms. [ ].” Information that can be inserted inside “[ ]” is private information. For example, in a case where private information is to be included in the speech content (S111 in FIG. 4), a personal name “Sato” is inserted inside “[ ]”. In a case where private information is to be replaced with nonprivate information (S112 in FIG. 4), an alphabet letter “X” is inserted inside “[ ]”.

The following discusses a case in which speech content is determined with use of a speech template “Today's weather is [ ].” Information that can be inserted inside “[ ]” is nonprivate information. Both in a case where private information is to be included in the speech content and a case where private information is to be replaced with nonprivate information, the speech content determined is commonly, for example, “Today's weather is sunny.”

The following description will discuss, with reference to (c) of FIG. 5, a relationship between the type of information included in speech content and the confidentiality level of the information. (c) of FIG. 5 is a diagram illustrating a relationship between a type of information and a confidentiality level of the information. For example, as illustrated in (c) of FIG. 5, telephone number and email address are each personal information that is desirably kept unknown to a third party, and are each set a high confidentiality level, accordingly. However, personal name is personal information that does not have to be kept unknown to a third party, and is set a low confidentiality level, accordingly.

As described above, a confidentiality level may be set in advance to a message to be outputted by the smartphone 1 as speech. Then, in a case where (i) the person state identifying section 13 has identified a plurality of persons and (ii) the speech permission determining section 14 has determined that speech is to be outputted, the speech content determining section 15 may determine speech content so that a message outputted as speech has a lower confidentiality level in accordance with an increase in the number of the persons identified. Whether the confidentiality level is high or low may be set as illustrated in (c) of FIG. 5. Note that although (c) of FIG. 5 illustrates an example in which the confidentiality level consists of two stages: high and low, the number of stages of the confidentiality level may be made larger. In such a case, it becomes possible to, for example, (i) cause a message of a high confidentiality level to be outputted as speech in a case where one (1) person has been detected in the vicinity of the smartphone 1, (ii) cause a message of an approximately middle confidentiality level to be outputted as speech in a case where two persons have been detected in the vicinity of the smartphone 1, and (iii) cause a message of a low confidentiality level to be outputted as speech in a case where three or more persons have been detected in the vicinity of the smartphone 1.

Further, in a case where (i) the person state identifying section 13 has identified a predetermined person and another person and (ii) the speech permission determining section 14 has determined that speech is to be outputted, the speech content determining section 15 may cause a message of a confidentiality level corresponding to who the another person is to be outputted as speech. Whether the confidentiality level is high or low may be set as illustrated in (c) of FIG. 5. This makes it possible to output, while preventing private information related to a predetermined person from being leaked to a predetermined another person to whom the private information is desirably kept unknown, speech content which it is appropriate to output even in the presence of such another person.

Further, the speech content determining section 15 may cause a message of a confidentiality level corresponding to a combination of a person(s) identified by the person state identifying section 13 and the number of the person(s) identified. For example, in a case where only two persons, namely, a user of the smartphone 1 and a predetermined another person (e.g., a member of the user's family or a close friend of the user) have been detected, the speech content determining section 15 may cause a message of an approximately middle confidentiality level to be outputted as speech.

### Modified Example

The embodiment described above has dealt with an example in which the smartphone 1 carries out a “speaking” operation, but the smartphone 1 may carry out a “conversing” operation instead. That is, the smartphone 1 may determine a response sentence corresponding to a result of audio recognition of speech made by a user, and output the response sentence as speech with use of audio. In this case, similarly as in the case of carrying out the speaking operation, the smartphone 1 (i) analyzes captured images of the vicinity of the smartphone 1 so as to carry out at least one of a process of making an identification of a person(s) in the vicinity of the smartphone 1 and a process of making an identification of the number of the person(s) in the vicinity of the smartphone 1 and (ii) determines, on the basis of a result of the identification, whether or not speech is to be outputted. In a case where the smartphone 1 has determined that speech is to be outputted, it is preferable that the smartphone 1 determine, in accordance with at least one of (i) who the person(s) in the vicinity of the smartphone 1 is/are and (ii) the number of the person(s) in the vicinity of the smartphone 1, whether or not personal information or the like is to be included in the response sentence. In a case where the smartphone 1 has determined that personal information is not to be included in the response sentence, the smartphone 1 may output a response sentence from which personal information has been excluded or may output a response sentence in which personal information has been replaced with nonpersonal information.

Note that examples of a method of determining a response sentence corresponding to speech content outputted by a user encompass a method of using a database in which speech content outputted by the user and a response sentence corresponding to the speech content are stored so as to be associated with each other.

[Software Implementation Example]

Control blocks of the smartphone 1 (particularly, the person state identifying section 13, the speech permission determining section 14 and the speech content determining section 15) can be realized by a logic circuit (hardware) provided in an integrated circuit (IC chip) or the like or can be alternatively realized by software as executed by a central processing unit (CPU).

In the latter case, the smartphone 1 includes a CPU that executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be made available to the computer via any transmission medium (such as a communication network or a broadcast wave) which allows the program to be transmitted. Note that the present invention can also be achieved in the form of a computer data signal in which the program is embodied via electronic transmission and which is embedded in a carrier wave.

Aspects of the present invention can also be expressed as follows:

A speech device (smartphone 1) in accordance with Aspect 1 of the present invention is a speech device which has a function of outputting speech with use of audio, including: a person state identifying section (13) configured to analyze a captured image of the vicinity of the speech device so as to carry out at least one of (i) a process of making an identification of a person in the vicinity of the speech device and (ii) a process of making an identification of the number of the person in the vicinity of the speech device; and a speech permission determining section (14) configured to determine, on the basis of a result of the identification, whether or not speech is to be outputted.

With the configuration, whether or not speech is to be outputted is determined in accordance with a result of identification of a person(s) in the vicinity of the speech device or a result of identification of the number of the person(s) in the vicinity of the speech device. This makes it possible to prevent speech outputted by the speech device from causing leakage of personal information or the like to a third party.

In Aspect 2 of the present invention, the speech device in accordance with Aspect 1 may be configured such that the speech permission determining section determines that speech is to be outputted, in a case where a predetermined number of predetermined person has been identified by the person state identifying section. With this configuration, the speech device is caused to output speech only in a case where the number of the person(s) in the vicinity of the speech device is limited to the predetermined number (e.g., one (1)). This allows preventing speech outputted by the speech device from causing leakage of personal information or the like to a third party.

In Aspect 3 of the present invention, the speech device in accordance with Aspect 1 may be configured such that the speech permission determining section determines that speech is not to be outputted, in a case where the number of the person identified by the person state identifying section is not less than a predetermined number. In a case where the number of the person(s) in the vicinity of the speech device is not less than the predetermined number, it is highly likely that a third party who is not the owner of the speech device is included among the person(s). As such, by determining that speech is not to be outputted in a case where the number of the person(s) identified is not less than the predetermined number, it is possible to prevent leakage of personal information or the like of the owner of the speech device to a third party.

In Aspect 4 of the present invention, the speech device in accordance with Aspect 2 may be configured such that the predetermined person is a person in the presence of whom the speech device is permitted to output speech including personal information, the speech device further including: a speech content determining section (15) configured to, in a case where the speech permission determining section has determined that speech is to be outputted, include in content of the speech personal information of the person in the presence of whom the speech device has been permitted to output speech including personal information. In a case where (i) a predetermined number of predetermined person(s) has/have been identified and (ii) each of the predetermined person(s) is a person in the presence of whom the speech device is permitted to output speech including personal information, no problem arises from including personal information in content of the speech, since there is no risk of leaking, to a third party, personal information of the person in the presence of whom the speech device is permitted to output speech including personal information. Accordingly, in a situation in which nobody is present except for the person in the presence of whom the speech device is permitted to output speech including personal information, a conversation can be held on a wide range of topics including a private topic involving the personal information or the like.

In Aspect 5 of the present invention, the speech device in accordance with Aspect 1 may be configured such that the speech device further includes a speech content determining section (15) configured to, in a case where (a) the person state identifying section has identified a predetermined person and another person and (b) the speech permission determining section has determined that speech is to be outputted, (i) exclude personal information of the predetermined person from content of the speech or (ii) replace the personal information with nonpersonal information. The configuration enables a conversation between the smartphone 1 and a user while preventing leakage of personal information or the like of a predetermined person to a third party.

In Aspect 6 of the present invention, the speech device in accordance with Aspect 1 may be configured such that a confidentiality level is set in advance to a message to be outputted by the speech device, the speech device further including: a speech content determining section (15) configured to, in a case where (i) the person state identifying section has identified a plurality of persons and (ii) the speech permission determining section has determined that speech is to be outputted, cause a message of a lower confidentiality level to be outputted, as speech, in accordance with an increase in the number of the plurality of persons who have been identified. With this configuration, a confidentiality level for a message that can be outputted as speech is lowered in accordance with an increase in the number of the persons identified. This makes it possible, even in a situation in which a large number of people are in the vicinity of the speech device, to cause the speech device to output speech while preventing a message of a high confidentiality level from being conveyed to the large number of people.

In Aspect 7 of the present invention, the speech device in accordance with Aspect 1 may be configured such that: a confidentiality level is set in advance to a message to be outputted by the speech device, the speech device further including: a speech content determining section (15) configured to, in a case where (i) the person state identifying section has identified a predetermined person and another person and (ii) the speech permission determining section has determined that speech is to be outputted, cause a message of a confidentiality level, corresponding to who the another person is, to be outputted as speech. The configuration allows adjusting, in accordance with who the another person is, a confidentiality level for a message that can be outputted as speech.

A method for controlling a speech device in accordance with Aspect 8 of the present invention is a method for controlling a speech device which has a function of outputting speech with use of audio, the method including the steps of: (a) a person state identifying step of analyzing a captured image of the vicinity of the speech device so as to carry out at least one of (i) a process of making an identification of a person in the vicinity of the speech device and (ii) a process of making an identification of the number of the person in the vicinity of the speech device; and (b) a speech permission determining step of determining, on the basis of a result of the identification, whether or not speech is to be outputted. The above method brings about effects similar to those of Aspect 1.

A speech device in accordance with each aspect of the present invention can be realized by a computer. The computer is operated based on (i) a control program for causing the computer to realize the speech device by causing the computer to operate as each section (software element) included in the speech device and (ii) a computer-readable storage medium in which the control program is stored. Such a control program and a computer-readable storage medium are included in the scope of the present invention.

Supplementary Note

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1: smartphone (speech device)
13: person state identifying section
14: speech permission determining section
15: speech content determining section

1. A speech device which has a function of outputting speech with use of audio, comprising:
a person state identifying section configured to analyze a captured image of the vicinity of the speech device so as to carry out at least one of (i) a process of making an identification of a person in the vicinity of the speech device and (ii) a process of making an identification of the number of the person in the vicinity of the speech device; and
a speech permission determining section configured to determine, on the basis of a result of the identification, whether or not speech is to be outputted.

2. The speech device as set forth in claim 1, wherein the speech permission determining section determines that speech is to be outputted, in a case where a predetermined number of predetermined person has been identified by the person state identifying section.

3. The speech device as set forth in claim 1, wherein the speech permission determining section determines that speech is not to be outputted, in a case where the number of the person identified by the person state identifying section is not less than a predetermined number.

4. A speech device as set forth in claim 2, wherein the predetermined person is a person in the presence of whom the speech device is permitted to output speech including personal information,
said speech device, further comprising:
a speech content determining section configured to, in a case where the speech permission determining section has determined that speech is to be outputted, include in content of the speech personal information of the person in the presence of whom the speech device has been permitted to output speech including personal information.

5. A speech device as set forth in claim 1, further comprising:
a speech content determining section configured to, in a case where (a) the person state identifying section has identified a predetermined person and another person and (b) the speech permission determining section has determined that speech is to be outputted, (i) exclude personal information of the predetermined person from content of the speech or (ii) replace the personal information with nonpersonal information.

6. The speech device as set forth in claim 1, wherein:
a confidentiality level is set in advance to a message to be outputted by the speech device,
said speech device, further comprising:
a speech content determining section configured to, in a case where (i) the person state identifying section has identified a plurality of persons and (ii) the speech permission determining section has determined that speech is to be outputted, cause a message of a lower confidentiality level to be outputted, as speech, in accordance with an increase in the number of the plurality of persons who have been identified.

7. A speech device as set forth in claim 1, wherein:
a confidentiality level is set in advance to a message to be outputted by the speech device,
said speech device, further comprising:
a speech content determining section configured to, in a case where (i) the person state identifying section has identified a predetermined person and another person and (ii) the speech permission determining section has determined that speech is to be outputted, cause a message of a confidentiality level, corresponding to who the another person is, to be outputted as speech.

8. A method for controlling a speech device which has a function of outputting speech with use of audio,
said method comprising the steps of:
(a) a person state identifying step of analyzing a captured image of the vicinity of the speech device so as to carry out at least one of (i) a process of making an identification of a person in the vicinity of the speech device and (ii) a process of making an identification of the number of the person in the vicinity of the speech device; and
(b) a speech permission determining step of determining, on the basis of a result of the identification, whether or not speech is to be outputted.

9. A computer-readable non-transitory storage medium that stores a control program for causing a computer to function as the speech device recited in claim 1,
said control program causing the computer to function as the person state identifying section and the speech permission determining section.
